(19) United States
(12) Patent Application Publication
(10) Pub. No.: US 2005/0011239 A1
(43) Pub. Date: Jan. 20, 2005

(54) Convertible mortise/rim cylinder lock assembly with removable core

(76) Inventors: Alan E. Lurie, Centerport, NY (US); Joseph Thomas, New Hyde Park, NY (US); William H. Bullwinkel, Plainview, NY (US)

Correspondence Address: Christopher G. Trainor;Carter, DeLuca, Farrell & Schmidt, LLP, Suite 225, 445 Broad Hollow Road, Melville, NY, 11747, US

(21) Appl. No.: 10/858,987

(22) Filed: Jun. 1, 2004

Related U.S. Application Data
(60) Provisional application No. 60/475,046, filed on Jun. 3, 2003.

(51) Int. Cl. E05B 9/04

(52) U.S. Cl. 70/369; 70/371

(57) ABSTRACT

A convertible mortise/rim cylinder lock assembly having a removable core is disclosed. The lock assembly includes a housing having a longitudinal bore, a removable core dimensioned to be received within the longitudinal bore, a drive member and an actuator. The lock assembly includes a drive member retainer assembly which rotatably secures the drive member within the longitudinal bore of the lock assembly housing. The removable core is removable from the housing independently of the drive member. A core retainer member is provided on the removable core to prevent removal of the core from the lock housing when the removable core is in a locked position. The lock assembly may include a kit having mortise and rim cylinder actuator configurations. The selected actuator may be secured to the drive member to selectively adapt the lock assembly for use as a mortise or a rim cylinder lock assembly.

This application claims priority from U.S. provisional patent application Ser. No. 60/475,046, filed May 30, 2003, the entirety of which is incorporated herein by reference.

### BACKGROUND

1. Technical Field

The present disclosure relates to a lock assembly. More particularly, the present disclosure relates to a lock assembly which is convertible between a mortise lock assembly and a rim cylinder lock assembly and includes a removable core.

2. Background of Related Art

Lock assemblies including removable cores are well known in the art. By providing a removable core in a lock assembly, replacement of the entire lock assembly is not required if, for example, a key is lost or misplaced. Rather, only the removable core need be replaced, and this can be accomplished quickly and inexpensively using a control key in a manner also known in the art. Thus, the use of removable core lock assemblies results in savings in both time and expense. These savings may be substantial for businesses that use hundreds of locks on a daily basis, e.g., department stores.

Mortise lock assemblies are typically used for entrance way door locks, for example, business door locks, and rim cylinder lock assemblies are typically used for deadbolt locks on, for example, residential apartments or homes. When it is necessary to change these locks, e.g., when a key is lost or a new resident moves into an apartment, the entire lock must be removed from the door or support structure and replaced. Such replacement can be time consuming and expensive and may result in damage to the support structure during mounting of the new lock assembly.

Mortise lock assemblies typically include a threaded housing which is threaded directly into a support structure such as a door and a rotatable actuator having a radially extending arm for actuating a bolt of the lock assembly. Rim cylinder lock assemblies typically include a non-threaded housing which is secured to a support structure with screws and includes a longitudinally extending actuator. As such, locksmiths routinely maintain an inventory of both mortise and rim cylinder lock assemblies to ensure that they will have the proper hardware when called upon by a consumer.

Accordingly, a continuing need exists for a convertible rim cylinder/mortise lock assembly having a removable core. A continuing need also exists for a lock assembly which can be adapted for use as both a mortise lock assembly or a rim cylinder lock assembly. This would allow consumers, e.g., locksmiths, to maintain smaller inventories at reduced expense while providing the benefits associated with removable core locks.

### SUMMARY

In accordance with the present disclosure, a convertible mortise/rim cylinder lock assembly having a removable core is provided. The lock assembly includes a lock housing defining a longitudinal bore, a removable core positioned within the lock housing longitudinal bore, a drive member releasably engaged with the removable core, an actuator, and a securement member. The drive member is axially retained in the longitudinal bore of the lock housing by a drive member retainer assembly which includes a screw, a detent and a biasing member. The biasing member urges the detent into the drive member also to prevent rotation of the drive member independent of the removable core.

The lock assembly includes a core retainer member which extends radially from an outer surface of the removable core. When the removable core is in its locked position, the core retainer member is positioned behind a shoulder formed along a surface defining the longitudinal bore of the lock housing to prevent removal of the removable core from the lock housing. In one embodiment, the core retainer member includes a pin which may be formed from hardened steel.

The actuator and securement member may be selected to provide a mortise lock assembly or a rim cylinder lock assembly. The securement member is adapted to fixedly secure the actuator to the rear end of the drive member. A kit may be provided which includes a mortise drive member, actuator, and securement member, and a rim cylinder drive member, actuator and securement member to allow configuration of the lock assembly for mortise or rim cylinder lock use.

The lock housing may be constructed from hardened steel to prevent tampering with and/or bypassing the lock assembly. Alternately, other materials of construction may be used.

### BRIEF DESCRIPTION OF THE DRAWINGS

Various embodiments of the presently disclosed convertible mortise/rim cylinder lock assembly with removable core are described herein with reference to the drawings, wherein:

FIG. 1 is a side perspective view from the rear, with parts separated, of the common components of one embodiment of the presently disclosed convertible mortise/rim cylinder lock assembly;

FIG. 2 is a side perspective view from the rear, with parts separated, of the presently disclosed lock assembly adapted for use as a rim cylinder lock assembly;

FIG. 3 is an assembled side perspective view from the rear of the rim cylinder lock assembly shown in FIG. 2;

FIG. 4 is a side perspective view from the rear of the drive member of the rim cylinder lock assembly shown in FIG. 3;

FIG. 5 is a side perspective cross-sectional view from the rear of the rim cylinder lock assembly shown in FIG. 3;

FIG. 5a is a side view of the removable core and drive member of the rim cylinder lock assembly shown in FIG. 3 with a control key, shown partly in phantom, inserted in the key slot of the removable core;

FIG. 5b is a side view of the removable core and drive member shown in FIG. 5a with an operating key inserted in the key slot of the removable core;

FIG. 5c is a side perspective view with parts separated of the removable core and drive member shown in FIG. 5b;

FIG. 5d is a front view of the lock housing of the rim cylinder lock assembly shown in FIG. 3;

FIG. 6 is a side perspective cross-sectional view from the rear of the rim cylinder lock assembly shown in FIG. 5 rotated about its longitudinal axis 90°;

FIG. 7 is a side perspective view from the rear, with parts separated, of the presently disclosed lock assembly adapted for use as a mortise lock assembly;

FIG. 8 is an assembled side perspective view from the rear of the mortise lock assembly shown in FIG. 7;

FIG. 9 is a side perspective view from the rear of the drive member of the mortise lock assembly shown in FIG. 7;

FIG. 10 is a side perspective cross-sectional view from the rear of the mortise lock assembly shown in FIG. 8; and

FIG. 11 is a side perspective cross-sectional view from the rear of the mortise lock assembly shown in FIG. 10 rotated about its longitudinal axis 90°.

### DETAILED DESCRIPTION OF EMBODIMENTS

Various embodiments of the presently disclosed convertible mortise/rim cylinder lock assembly with removable core will now be described in detail with reference to the drawings, wherein like reference numerals designate identical or corresponding elements in each of the several views.

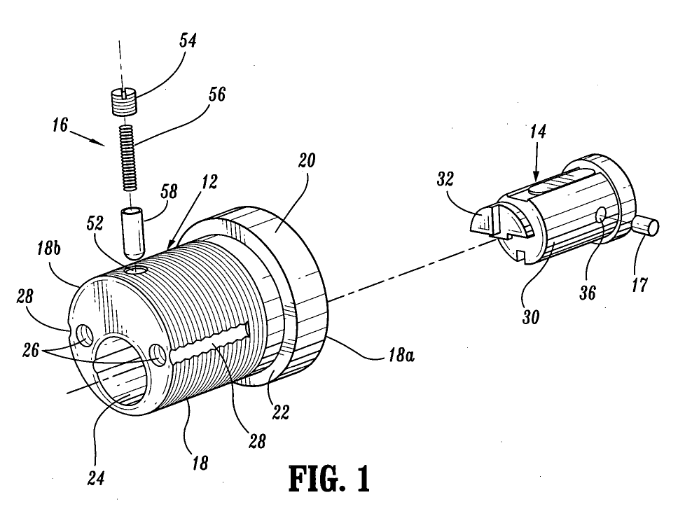

FIG. 1 illustrates the generic components of the presently disclosed convertible mortise/rim cylinder lock assembly which include a lock housing 12, a removable core 14, a drive member retainer assembly 16 and a core retainer member 17 which will be discussed in further detail below. Lock housing 12 includes a threaded body 18 which is substantially cylindrical and has an enlarged diameter head portion 20 defining an annular shoulder 22. A longitudinal bore 24 extends from a front end 18a of body 18 to a rear end 18b of body 18. A pair of diametrically opposed threaded bores 26 are formed in rear end 18b of body 18. Threaded bores 26 are configured to receive retaining screws (not shown) to secure lock housing 12 to an apparatus, e.g., a door, when the lock assembly is configured for use as a rim cylinder lock assembly. Diametrically opposed longitudinal grooves 28 are formed along an outer surface of threaded body 18 and provide an engagement surface for a set screw (not shown) for rotatably and axially securing housing 12 to the support body. In one embodiment, lock housing 12 is constructed from hardened steel which prevents drilling into the lock housing to bypass or unlock the lock assembly. Alternately, other materials of construction may be used.

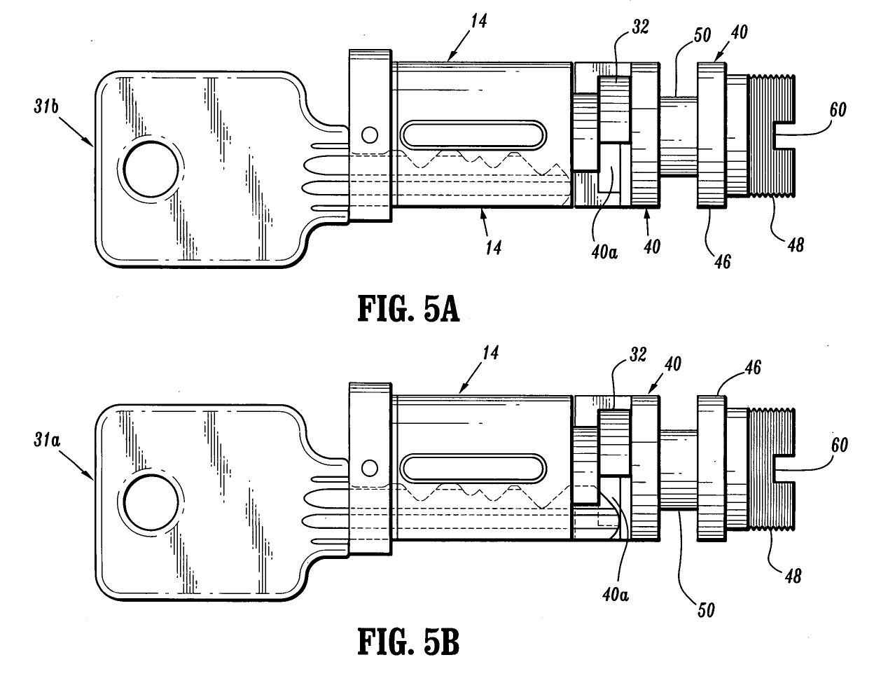

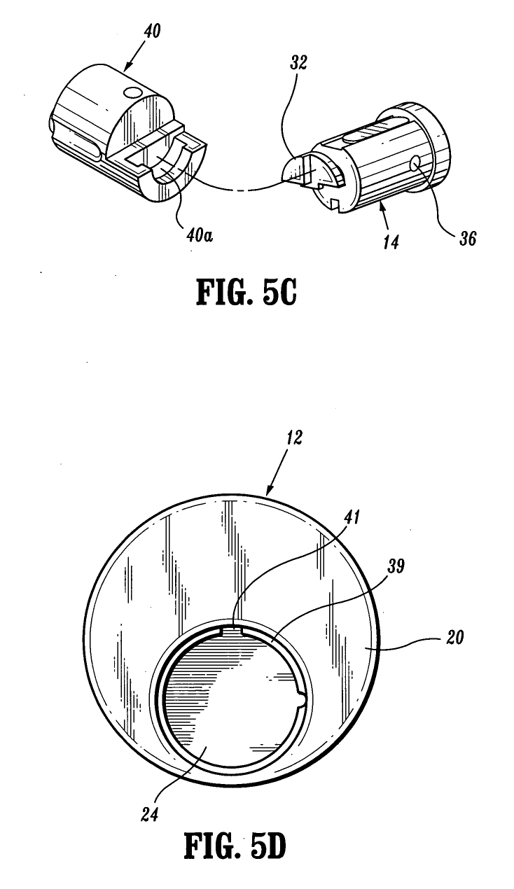

Removable core 14 includes a substantially cylindrical body 30 having a key slot (not shown) formed thorough a front face(not shown) thereof. The key slot is configured to receive an operating key 31a (FIG. 5B) and a control key 31b (FIG. 5A). Control key 31b facilitates removal of removable core 14 from housing 12. Operating key 31a facilitates operation of drive member 40. As shown in FIGS. 5A and 5B, operating key 31a extends through the key slot to a position engaging drive member 40, whereas control key 31b only extends substantially the length of removable core 14 and does not engage drive member 40. An engagement member 32 is positioned on the rear end of removable core 14 and is rotatable therewith in response to rotation of a key positioned within the key slot.

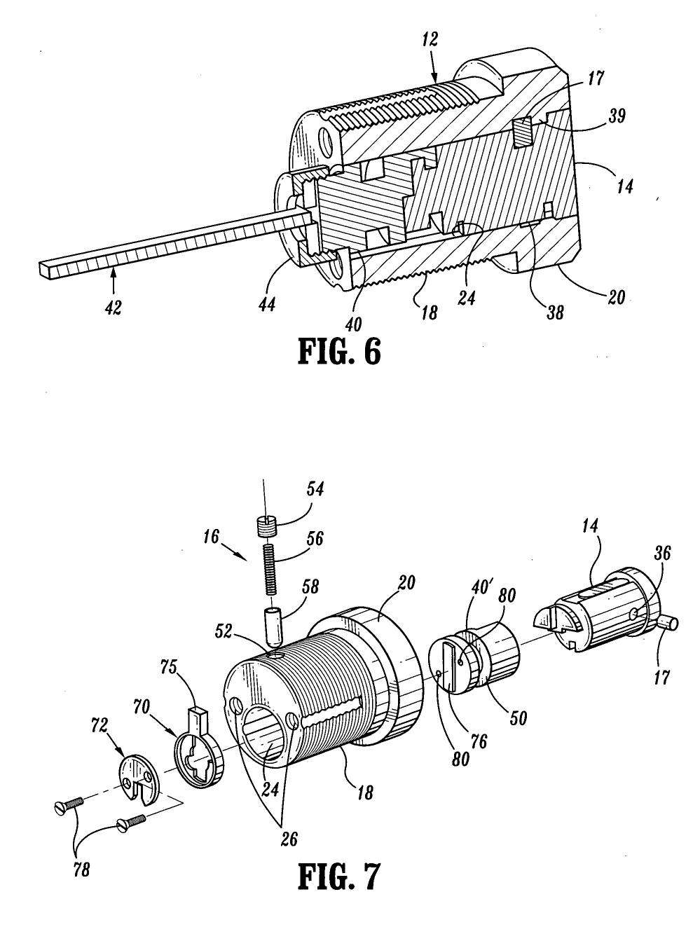

A core retainer member 17 is positioned partially within a bore 36 formed in removable core 14, i.e., retainer member 17 extends from bore 36. In one embodiment, core retainer member 17 includes a pin formed of hardened steel. Pin 17 extends from bore 36 and is dimensioned to be received within an annular channel 38 defined between a pair of annular walls 39 formed about longitudinal bore 24 (FIGS. 5 and 6). Alternately, only one annular wall 39 may be provided which defines a shoulder positioned to prevent removal of pin 17 from bore 24. A window 41 (FIG. 5D) is provided in annular wall 39 to facilitate positioning of pin 17 within channel 38 (FIG. 5D). Receipt of pin 17 within channel 38 prevents removable core 14 from being pulled from longitudinal bore 24. More specifically, in the locked position of removable core 14, pin 17 is spaced from window 41 behind annular wall 39 to prevent axial movement of removable core 14 from within longitudinal bore 24.

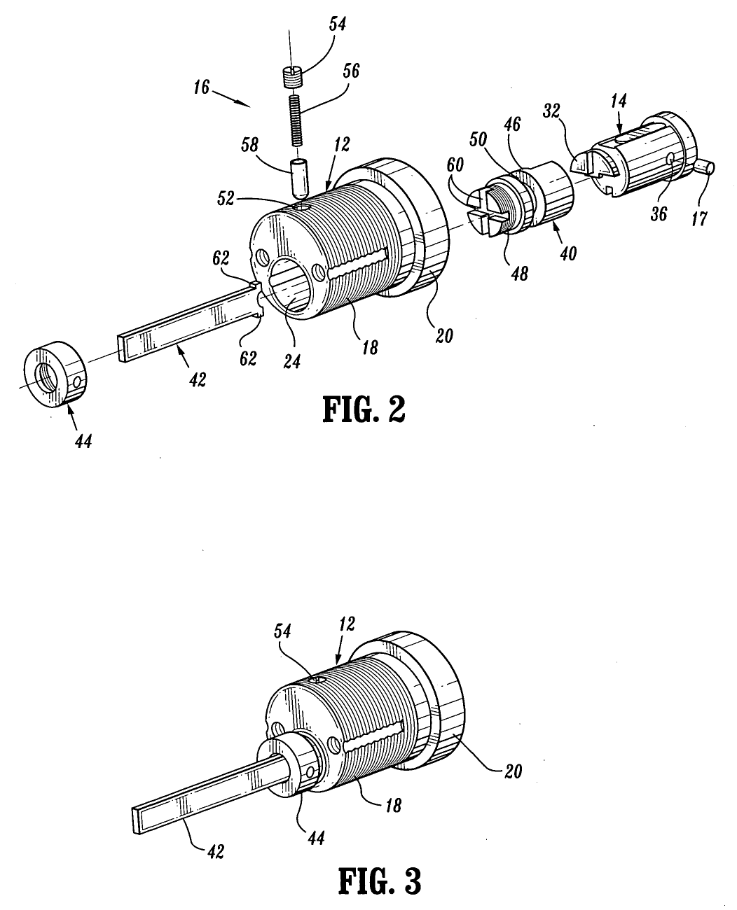

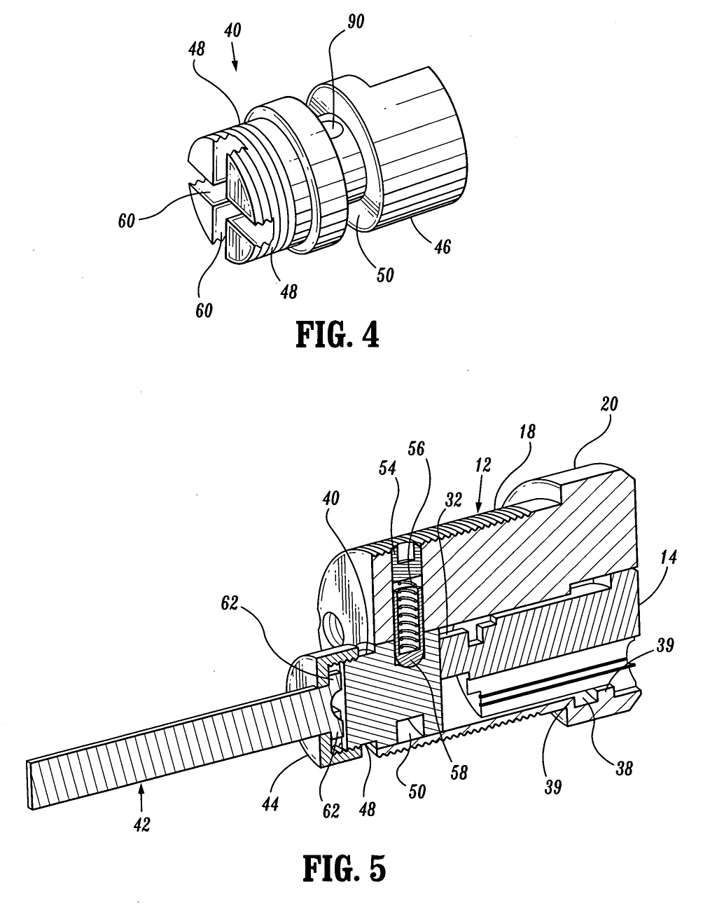

FIGS. 2-6 illustrate the generic components of the presently disclosed lock assembly in combination with additional components for converting the lock assembly to a rim cylinder lock assembly. These additional components include a drive member 40, an actuator 42, and a securement member 44. Drive member 40 is dimensioned to be received within longitudinal bore 24 of lock housing 12 and includes a substantially cylindrical body portion 46 having a threaded rear end 48 and an annular channel 50 formed about a central portion thereof (FIG. 4). The front end of drive member 40 is configured to non-rotatably and releasably mate with or engage engagement member 32 of removable core 14 such that rotation of core 14 effects rotation of drive member 40 (FIG. 5C). More specifically, the front end of drive member 40 includes a semi-circular recess 40a for receiving engagement member 32 of removable core 14 which has a corresponding shape. Although illustrated as defining interlocking structure, it is contemplated that other structure, devices, or techniques may be used to releasably mate or engage drive member 40 with engagement member 32.

As discussed above, drive member 40 is rotatably positioned within longitudinal bore 24 of lock housing 12. A threaded radial bore 52 is formed through lock housing 12 and communicates with longitudinal bore 24. Bore 52 is dimensioned to receive drive member retainer assembly 16 therein as will be discussed in further detailed below.

Drive member retainer assembly 16 includes a screw 54, a biasing member 56, and a detent 58. Biasing member 56, which may be in the form of a coil spring, is positioned within bore 52 between screw 54 and detent 58. Detent 58 is dimensioned to extend into annular channel 50 of drive member 40 and engage a concavity or opening 90 formed in drive member 40. Biasing member 56 urges detent 58 into concavity 90 of channel 50 to maintain the axial position of drive member 40 within longitudinal bore 24. The force exerted by biasing member 56 on detent 58 and translated to the force of detent 58 on drive member 40 should also be sufficient to prevent drive member 40 from rotating within longitudinal bore 24 independently of rotation of removable core 14 and the operating key. Such may occur when core 14 has been removed and the lock assembly is shaken, e.g., during door closure, and may affect operation of the lock assembly.

The rear face of drive member 40 includes a pair of intersecting linear slots 60 which define a t-shaped recess. Actuator 42, which may be in the form of an elongated tail member, includes a pair of transversely extending fingers 62 which are dimensioned to be received within a linear slot 60. An annular, threaded securement member 44 is slidable over actuator 42 and is threadably received on threaded rear end 48 of drive member 40 to fixably secure actuator 42 to drive member 40.

In use, when an operating key is inserted into removable core 14 and turned to rotate core 14, the operating key extends beyond removable core 14 into engagement with drive. member 40 to effect rotation of drive member 40, which in turn, effects rotation of actuator 42. Actuator 42 communicates in a known manner with a bolt (not shown) of the lock assembly such that rotation of actuator 42 operates the bolt of the lock assembly to lock or unlock the lock assembly.

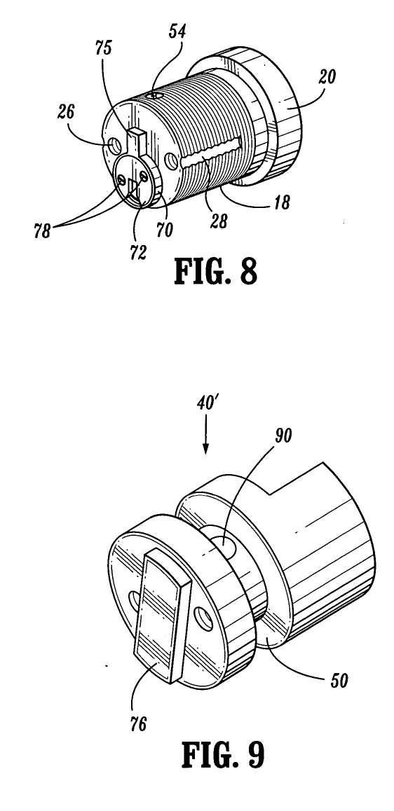

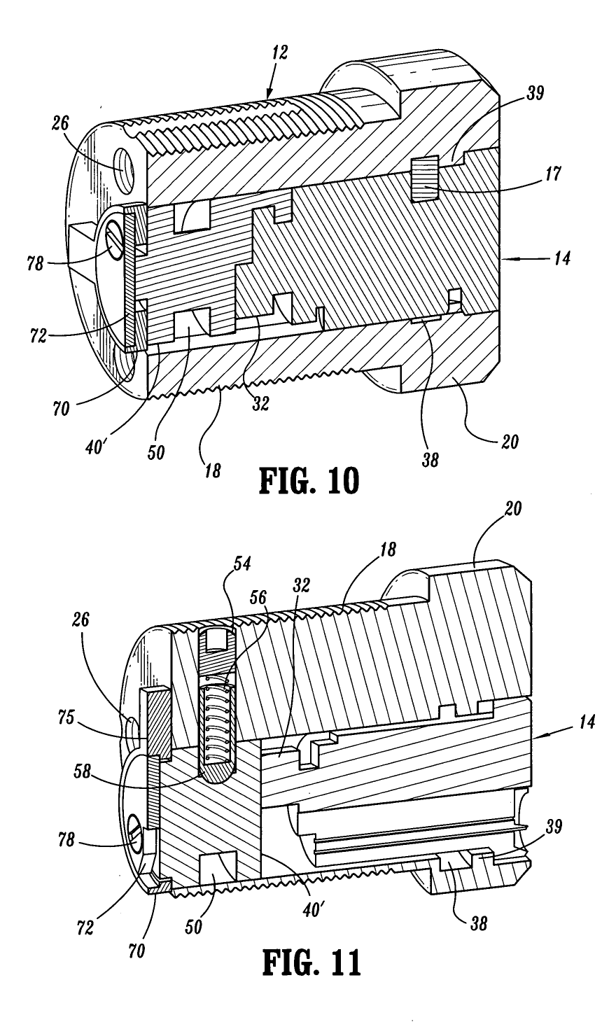

FIGS. 7-11 illustrates the generic components of the presently disclosed lock assembly in combination with additional components for converting the lock assembly to a mortise lock assembly. The common components and their operation including lock housing 12, removable core 14, retainer assembly 16 and core retainer member 17 are as described above and will not be described in detail with respect to this embodiment. Minor modifications have been made to drive member 40 and will be discussed below.

The additional components comprising the mortise lock assembly include an actuator 70 and a securement member 72. Actuator 70 includes a circular cam body 72 having a cutout 74 and a radially extending arm 75. Cutout 74 is dimensioned to receive a rectangular protrusion 76 formed on a rear face of modified drive member 40′, such that rotation of drive member 40′ effects corresponding rotation of actuator 70. Securement member 72 may be in the form of a circular plate having at least one, and preferably two, bores 76 for receiving screws 78 for securing securement member 72 and actuator 70 to the rear face of drive member 40′. The rear face of drive member 40 includes threaded bores 80 for receiving screws 78.

In use, when an operating key is inserted into the keyslot of removable core 14 and turned to rotate core 14, drive member 40′, via engagement member 32, is rotated to effect rotation of actuator 70. When actuator 70 rotates, arm 75 is rotated to operate the bolt of the lock assembly in a known manner.

The above described lock assembly may be provided in kit form wherein the kit includes at least one lock housing 12, at least one removable core 14, at least one drive member 40, at least one drive member 40′, at least one of actuators 42 and 70 and at least one of securement members 44 and 72. Such a kit would allow a person, e.g., a locksmith to selectively create a mortise lock assembly or a rim cylinder lock assembly using a simple lock housing and removable core.

It will be understood that various modifications may be made to the embodiments disclosed herein. For example, the components of the lock assembly can be formed of any material having the required strength characteristics. Further, the configurations of the drive member, removable core and/or the actuator may varied from that shown without departing from the teachings of this disclosure. Therefore, the above description should not be construed as limiting, but merely as exemplifications of disclosed embodiments. Those skilled in the are will envision other modifications within the scope and spirit of the claims appended here to.

1. A lock assembly comprising:
a housing having a front end, a rear end, a longitudinal substantially cylindrical bore extending from the front end of the housing to the rear end of the housing, and an annular wall formed about the longitudinal bore;
a removable core having a key slot formed in a front end thereof, the removable core being releasably received within the longitudinal bore of the housing and being operably associated with a drive member; and
a core retainer member supported on the removable core and extending radially outwardly from an outer surface thereof;
wherein when the removable core is in the locked position, the annular wall is positioned to engage the core retainer member to prevent removal of the removable core from the longitudinal bore of the housing.

2. A lock assembly according to claim 1, wherein the housing is formed from hardened steel.

3. A lock assembly according to claim 2, wherein the core retainer member is formed from hardened steel.

4. A lock assembly according to claim 1, wherein the core retainer member includes a pin.

5. A lock assembly according to claim 1, wherein the annular wall includes a window to facilitate insertion and removal of the removable core from the longitudinal bore of the housing.

6. A lock assembly according to claim 1, wherein the drive member is positioned in the longitudinal bore of the housing and is releasably engageable with the removable core such that the removable core is removable from the longitudinal bore of the housing independently of the drive member.

7. A lock assembly according to claim 6, wherein the drive member includes an annular channel formed therein, and further including a drive member retainer for axially retaining the drive member within the longitudinal bore.

8. A lock assembly according to claim 7, wherein the drive member retainer includes an assembly including a detent which extends from the housing into the annular channel of the drive member to retain the drive member at an axially fixed position within the longitudinal bore of the housing while permitting rotation of the drive member within the housing.

9. A lock assembly according to claim 8, wherein the drive member retainer assembly includes a biasing member for urging the detent into a concavity in the drive member to prevent rotation of the drive member independent of the removable core.

10. A lock assembly comprising;
a housing having a front end, a rear end and a substantially longitudinal bore;
a removable core rotatably positioned within the longitudinal bore; and
a drive member rotatably positioned within the longitudinal bore, the drive member being releasably associated with the removable core such that rotation of the removable core from a locked position to an unlocked position by an operating key effects rotation of the drive member, wherein the removable core is removable from the longitudinal bore independently of the drive member.

11. A lock assembly according to claim 10, further including a drive member retainer assembly including a detent for axially retaining the drive member within the longitudinal bore of the housing.

12. A lock assembly according to claim 11, wherein the drive member retainer assembly includes a biasing member for urging the detent into a concavity formed in the drive member to prevent rotation of the drive member independent of the removable core.

13. A lock assembly according to claim 12, wherein the housing includes a radial bore, the biasing member and detent being positioned at least partially within the radial bore.

14. A lock assembly according to claim 13, wherein the radial bore includes screw threads, and the drive member retainer assembly further includes a threaded screw which is received within the radial bore to retain the biasing member and detent within the radial bore.

15. A lock assembly according to claim 10, further including an actuator releasably coupled to the drive member, the actuator being configured to operate a bolt of the lock assembly.

16. A lock assembly according to claim 15, wherein the actuator includes an elongated member which is secured to a rear end of the drive member by a securement member such that the elongated member defines a longitudinal axis which is aligned with the longitudinal axis of the longitudinal bore of the housing, wherein the lock assembly is a rim cylinder lock assembly.

17. A lock assembly according to claim 16, wherein the rear end of the drive member includes external screw threads and the securement member is an internally threaded collar.

18. A lock assembly according to claim 15, wherein the actuator includes a circular cam having a radially extending arm for operating a bolt of the lock assembly, wherein the lock assembly is a mortise lock assembly.

19. A lock assembly according to claim 18, wherein the circular cam is secured to a rear face of the drive member using at least one screw.
